(19) United States
(12) Patent Application Publication
(10) Pub. No.: US 2026/0093542 A1
(43) Pub. Date: Apr. 2, 2026

(54) COMPUTER-READABLE RECORDING MEDIUM HAVING STORED THEREIN INFORMATION PROCESSING PROGRAM, INFORMATION PROCESSING DEVICE, AND INFORMATION PROCESSING METHOD

(71) Applicant: Fujitsu Limited, Kawasaki-shi (JP)

(72) Inventor: Akihiro TABUCHI, Nakano (JP)

(73) Assignee: Fujitsu Limited, Kawasaki-shi (JP)

(21) Appl. No.: 19/337,977

(22) Filed: Sep. 24, 2025

(30) Foreign Application Priority Data
Sep. 30, 2024 (JP) 2024-170789

(51) Int. Cl. G06F 9/50; G06F 17/18

(52) U.S. Cl. CPC G06F 9/5027; G06F 17/18

(57) ABSTRACT

A non-transitory computer-readable recording medium having stored therein an information processing program that causes a computer having a first calculation resource and a second calculation resource having higher processing performance than the first calculation resource to execute a process including: during execution of a process by the second calculation resource, calculating an expected value of a first time cost in a case of releasing the second calculation resource, an expected value of a second time cost in a case of continuously holding the second calculation resource, and a current third time cost; and releasing the second calculation resource when at least one of a first condition that the expected value of the first time cost is less than the expected value of the second time cost or a second condition that the current third time cost exceeds a predetermined time cost limit value is satisfied.

### CROSS-REFERENCE TO RELATED APPLICATION

This application is based upon and claims the benefit of priority of the prior Japanese Patent application No. 2024-170789, filed on Sep. 30, 2024, the entire contents of which are incorporated herein by reference.

### FIELD

The present embodiment relates to a computer-readable recording medium having stored therein information processing program, an information processing device, and an information processing method.

### BACKGROUND

It is known that processing performance is improved using a graphics processing unit (GPU) instead of a central processing unit (CPU) for execution of deep learning applications (hereinafter, referred to as deep learning apps) (for example, Patent Document 1).

In addition, with the rapid development of AI in recent years, there has been a surge in GPU prices and a shortage in supply. Therefore, it is important to efficiently share and use a small number of GPUs among multiple processes.

In a known job scheduler such as Slurm, since the GPU is kept exclusively occupied from the start to the end of process execution, it is not possible to simultaneously execute a number of jobs exceeding the number of GPUs. A job for which a GPU is unable to be secured is placed in a job queue, and waits until the process currently using the GPU is completely ended.

In addition, GPU preemption is known as a technique for efficiently utilizing GPUS. In GPU preemption, it is possible to externally stop a job that is using a GPU and transfer the right to use the GPU to another job. By periodically performing such GPU preemption, the GPU-using process can be switched on a time basis, and a subsequent job can utilize the GPU without waiting for the preceding job to be completely stopped.

For example, related arts are disclosed in Japanese National Publication of International Patent Application No. 2022-515302 (Patent Document 1), U.S. Patent Application Publication No. 2020/0073728 (Patent Document 2), Japanese National Publication of International Patent Application No. 2017-510004 (Patent Document 3), and U.S. Patent Application Publication No. 2010/0100655 (Patent Document 4).

### SUMMARY

According to an aspect of the embodiments, a non-transitory computer-readable recording medium having stored therein an information processing program that causes a computer having a first calculation resource and a second calculation resource having higher processing performance than the first calculation resource to execute a process including: during execution of a process by the second calculation resource, calculating an expected value of a first time cost in a case of releasing the second calculation resource, an expected value of a second time cost in a case of continuously holding the second calculation resource, and a current third time cost; and releasing the second calculation resource when at least one of a first condition that the expected value of the first time cost is less than the expected value of the second time cost or a second condition that the current third time cost exceeds a predetermined time cost limit value is satisfied.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a scheduling system according to an embodiment;

FIG. 2 is a block diagram illustrating a hardware (HW) configuration example of a computer that realizes functions of the scheduling system according to an embodiment;

FIG. 3 is a diagram for describing a cost in the scheduling system according to the embodiment;

FIG. 4 is a diagram illustrating an example of a graph of a probability density function f(d);

FIG. 5 is a diagram illustrating an example of program code and an SCC;

FIG. 6 is a diagram for describing a device continuity determination method in the scheduling system according to the embodiment;

FIG. 7 is a flowchart for describing processing in the scheduling system according to the embodiment;

FIG. 8 is a flowchart for describing processing in the scheduling system according to the embodiment; and

FIG. 9 is a diagram for describing an expected value of the cost in a case of holding a device.

### DESCRIPTION OF EMBODIMENT(S)

In GPU preemption, even if there is a period during which a GPU is not utilized during the execution of a process, the GPU continues to be occupied. In order to suppress such occupation of the GPU, it is needed to perform so-called fine-granularity allocation in which the GPU allocation is switched in accordance with a temporal change in the processing content of a deep learning application.

To achieve fine-granularity allocation of GPUs, it is desirable to release the GPUs, for example, when the process does not use the GPUs for a long time.

Here, when a process releases a GPU, processing for releasing the GPU (GPU release processing) is executed after processing using the GPU (user processing), and the GPU is released accordingly. Furthermore, when a process secures a GPU, processing for securing the GPU (GPU securing processing) is executed, and then processing using the GPU (user processing) can be executed.

During the execution of the GPU release processing and during the execution of the GPU securing processing, the GPU is secured by the process in both cases, and thus, the GPU release processing and the GPU securing processing constitute overhead related to GPU allocation.

In addition, the determination as to whether a process is using a GPU is triggered by a signal transmitted at regular intervals from a driver process to the process as an interrupt.

Here, even if the time during which the process does not use the GPU is short, in a case where the process is not using the GPU at the timing when this signal is transmitted, the above-described GPU release processing is executed. However, thereafter, after a lapse of a short time, the same process may use the same GPU again, in which case the GPU securing processing is performed.

That is, if a GPU is released at an inappropriate timing, unnecessary GPU release processing and GPU securing processing may occur, and the time needed for the process to secure the GPU and the execution time of the processing using the GPU by the process may increase.

Hereinafter, embodiments of the present information processing program, information processing device, and information processing method will be described with reference to the drawings. However, the embodiments described below are merely examples, and it is not intended to exclude the application of various modifications and techniques that are not explicitly described in the embodiments. That is, the present embodiment can be implemented in various modified forms without departing from the gist thereof. Each drawing is not intended to include only the components illustrated in the drawing but may include other functions and the like.

### (A) Configuration

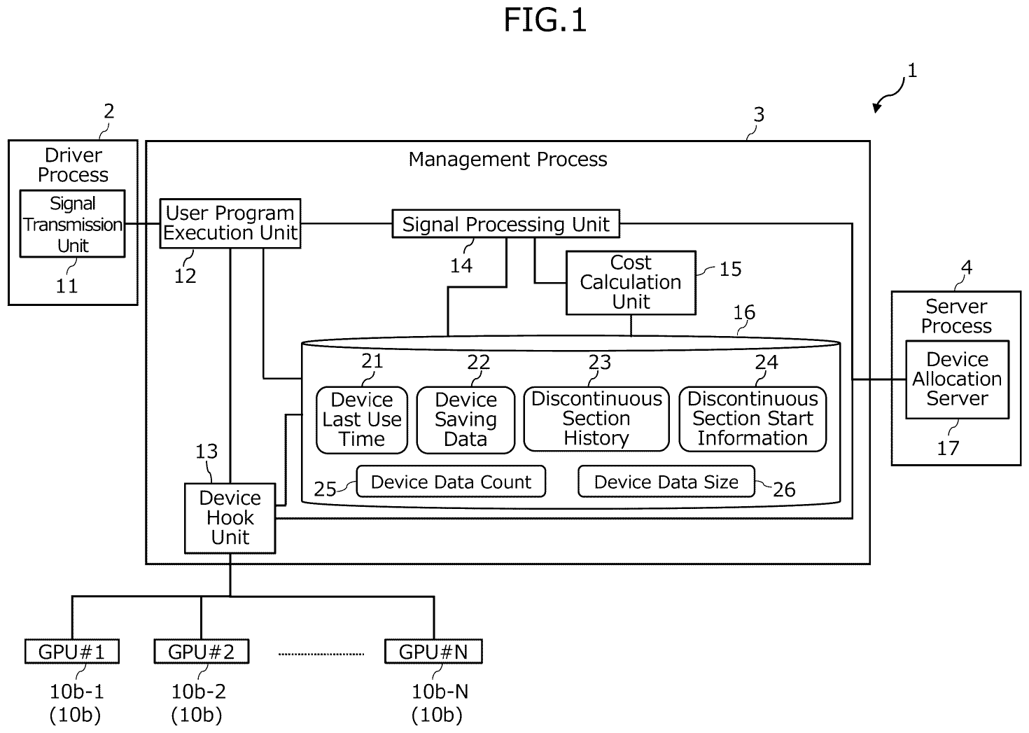

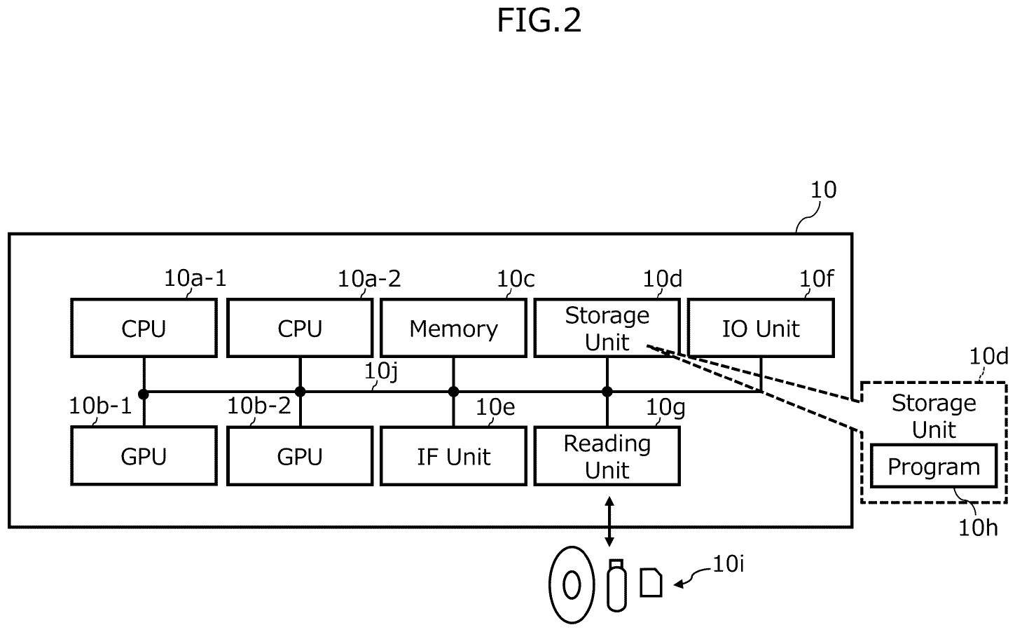

FIG. 1 is a diagram schematically illustrating a configuration of a scheduling system 1 according to an embodiment, and FIG. 2 is a block diagram illustrating a hardware (HW) configuration example of a computer 10 that realizes functions of the scheduling system 1 according to an embodiment.

### (A-1) Hardware Configuration Example

When a plurality of computers is used as the HW resource that realizes the functions of the scheduling system 1, each computer may have the HW configuration illustrated in FIG. 2.

The computer 10 is an information processing device, and as illustrated in FIG. 2, may include, as a HW configuration, for example, one or more (two in the example illustrated in FIG. 2) CPUs 10a-1 and 10a-2, one or more (two in the example illustrated in FIG. 2) GPUs 10b-1 and 10b-2, a memory 10c, a storage 10d, an interface (IF) 10e, an input/output (IO) 10f, and a reader 10g. Hereinafter, the CPUs 10a-1 and 10a-2 will be referred to as a CPU 10a unless particularly distinguished. Furthermore, the GPUs 10b-1 and 10b-2 will be referred to as a GPU 10b unless particularly distinguished.

The CPU 10a is an example of an arithmetic processing device that performs various controls and calculations, and is a controller that executes various processes. The CPU 10a may be communicably connected to each block in the computer 10 via a bus 10j. The bus 10j may be, for example, a PCIe (Peripheral Component Interconnect-Express) bus. Note that the CPU 10a may be a multiprocessor including a plurality of processors, may be a multicore processor including a plurality of processor cores, or may have a configuration including a plurality of multicore processors.

The GPU 10b may be, for example, an accelerator such as a GPGPU (General Purpose computing on Graphics processing unit). In addition, the GPU 10b may be used to control the screen display on output devices such as monitors within the IO 10f. The GPU 10b may have a configuration as an accelerator that executes machine learning processing and inference processing using a machine learning model. Regarding the machine learning processing and the inference processing, the GPU 10b may be said to have higher processing performance than the CPU 10a.

The CPUs 10a-1 and 10a-2, and the GPUs 10b-1 and 10b-2 are calculation resources allocated to a user program executed by a user program executer 12 described later. The CPUs 10a-1 and 10a-2 are examples of first calculation resources, and the GPUs 10b-1 and 10b-2 are examples of second calculation resources having higher processing performance than the CPUs 10a-1 and 10a-2 (first calculation resources). Hereinafter, the GPU 10b may be referred to as a device.

The GPU 10b-1 may be referred to as GPU #1, and the GPU 10b-2 may be referred to as GPU #2. In addition, the CPU 10a-1 may be referred to as CPU #1, and the CPU 10a-2 may be referred to as CPU #2.

The memory 10c is an example of HW that stores various pieces of information such as data and programs. Examples of the memory 10c include one or both of a volatile memory such as a dynamic random access memory (DRAM) and a nonvolatile memory such as a persistent memory (PM).

The storage 10d is an example of HW that stores various pieces of information such as data and programs. Examples of the storage 10d include various storage devices such as a magnetic disk device such as a hard disk drive (HDD), a semiconductor drive device such as a solid state drive (SSD), and a nonvolatile memory. Examples of the nonvolatile memory include a flash memory, a storage class memory (SCM), and a read only memory (ROM).

The storage 10d may store a program 10h (information processing program) that realizes all or part of various functions of the computer 10. For example, the CPU 10a of the scheduling system 1 can realize various functions to be described later by deploying the program 10h stored in the storage 10d in the memory 10c and executing the program.

In addition, the storage 10d may store various pieces of data used by the management process 3. The storage 10d may realize a function as a history information storage 16 described later.

The IF 10e is an example of a communication IF that controls connection and communication between the computer 10 and other computers. For example, the IF 10e may include an adapter conforming to optical communication such as a local area network (LAN) such as Ethernet®, and fiber channel (FC). The adapter may support one or both of wireless and wired communication systems. Note that the program 10h may be downloaded from the network to the computer 10 via the communication IF and stored in the storage 10d.

The IO 10f may include one or both of an input device and an output device. Examples of the input device include a keyboard, a mouse, and a touch panel. Examples of the output device include a monitor, a projector, and a printer. In addition, the IO 10f may include a touch panel or the like in which an input device and an output device are integrated. The output device may be connected to the GPU 10b. The IO 10f may be an input device or an output device of another information processing device remotely connected to the computer 10 by Secure Shell (SSH) or the like.

The reader 10g is an example of a reader that reads information such as data and programs recorded on a recording medium 10i. The reader 10g may include a connection terminal or device to which the recording medium 10i can be connected or inserted. Examples of the reader 10g include an adapter conforming to a universal serial bus (USB) or the like, a drive device that accesses a recording disk, and a card reader that accesses a flash memory such as an SD card. Note that the program 10h may be stored in the recording medium 10i, and the reader 10g may read the program 10h from the recording medium 10i and store the program in the storage 10d.

Examples of the recording medium 10i include a non-transitory computer-readable recording medium such as a magnetic/optical disk or a flash memory. Examples of the magnetic/optical disk include a flexible disk, a compact disc (CD), a digital versatile disc (DVD), a Blu-ray disc, and a holographic versatile disc (HVD). Examples of the flash memory include semiconductor memories such as a USB memory and an SD card.

The above-described hardware configuration of the computer 10 is an example. Therefore, hardware in the computer 10 may be increased or decreased (for example, addition or deletion of an optional block), divided, integrated in an optional combination, or a bus may be added or deleted as appropriate.

### (A-2) Functional Configuration Example

As illustrated in FIG. 1, the scheduling system 1 may exemplarily include functions as a driver process 2, a management process 3, and a server process 4. These functions may be realized by hardware of the computer 10 (see FIG. 2). Note that, in the example illustrated in FIG. 1, N GPUS 10b-1 to 10b-N are illustrated (N is a natural number of 1 or more).

The driver process 2 has a function as a signal transmitter 11. A signal processor 14 generates signals at regular intervals (dint) and transmits the signals to the user program executer 12. These signals are input to the user program executer 12 and the signal processor 14 as interrupts.

The management process 3 executes the user program and performs scheduling for allocating the GPU 10b (device) to one or more processes generated in response to the execution of the user program.

As illustrated in FIG. 1, the management process 3 has functions as the user program executer 12, a device hooker 13, the signal processor 14, a cost calculator 15, and a history information storage 16.

The user program executer 12 executes a user program. The user program may be, for example, a program that realizes a process of performing training (deep learning) of a deep learning model (machine learning model).

The user program executer 12 executes the user program to generate one or more processes. The user program (process) is processed using the GPU 10b or the CPU 10a.

Hereinafter, that the user program or the process is processed using the GPU 10b may be referred to as that the user program uses the device or that the process uses the device.

In a process (hereinafter, simply referred to as a process) generated by the user program, for example, by calling the API of the deep learning library in the learning processing of the deep learning model, the library provided by each API is called. The deep learning library is software that functions as a base of a user program. The deep learning library is software serving as a base for efficiently advancing the machine learning by the user program, and may include, for example, processing patterns frequently used in user programs.

In the scheduling system 1, an API call made by a user program is input to the device hooker 13 by a hook. In a case where no calculation resource is allocated to the user program, information on the calculation resource (GPU 10b) for executing the API call is transmitted from a device allocation server 17.

In addition, when the process being executed by the user program is moved to another calculation resource, an instruction to stop the user program or an instruction to restart a job in the moved calculation resource may be input from the device hooker 13 to the user program.

In the scheduling system 1, a plurality of user programs may be executed, and scheduling may be performed in which calculation resources (CPU 10a, GPU 10b) are allocated to each of the plurality of user programs and these processes are executed.

The user program is executed by the allocated calculation resource (CPU 10a, GPU 10b).

When the user program finishes using the calculation resources (GPU 10b, device), it may notify the scheduler that the calculation resources are to be released (release notification). For example, when the process using the GPU 10b is completed, the user program transmits a GPU release notification to the scheduler. When the process using the CPU 10a is completed, the user program may transmit a CPU release notification to the scheduler.

The signal transmitted from the signal transmitter 11 is input to the user program executer 12, and the user program executer 12 may temporarily stop the execution of the user program when this signal is input. The user program executer 12 may be realized by, for example, a Python® interpreter, and the user program executer 12 may execute a program of the device hooker 13 described later.

The device hooker 13 recognizes that the user program uses the device (GPU 10b). For example, an API call performed by the user program through a hook may be input to the device hooker 13, and whether or not the user program uses the GPU 10b may be determined on the basis of the API call. As a result, the device hooker 13 can recognize whether the process is requesting to use the GPU 10b. The device hooker 13 may detect the usage status of the GPU 10b. When detecting the use of the device by the user program, the device hooker 13 also checks whether the device is secured.

Furthermore, in a case where there is data (device data) being processed by the GPU 10b when the GPU 10b is released, the device hooker 13 stores (moves, saves) the device data in the history information storage 16 as device saving data 22.

Furthermore, in a case where there is device data saved for the GPU 10b before using the secured GPU 10b, the device hooker 13 reads the device data from the device saving data 22 and restores the device data to the GPU 10b.

The history information storage 16 stores various pieces of history information obtained as a result of execution of the user program by the user program executer 12.

In the example illustrated in FIG. 1, the history information storage 16 stores device final use time information 21, device saving data 22, a discontinuous section history 23, discontinuous section start information 24, device data count information 25, and device data size information 26.

The device last use time information 21 is a time when the process stopped using the device, and includes the execution completion time tₗₐₛₜ of the process last processed by the device. The device saving data 22 is data (device data) which was being processed by the device to be released. The discontinuous section history 23 includes a length dₕₒᵤₛₑ of a discontinuous (non-use) period of the device.

The discontinuous section start information 24 includes a program execution position (stmt) when the discontinuous section was detected and a time (t_{saved}) when the stmt was recorded. The device data count information 25 includes the number of pieces of data being processed by the device, and the device data size information 26 includes the size of the data being processed by the device.

These pieces of data are generated each time the device (GPU 10b) executes processing, and are generated for each device.

The cost calculator 15 calculates the time cost in accordance with an instruction from the signal processor 14 to be described later. In the scheduling system 1, a time during which the GPU 10b (device) is unavailable for effective use is defined as a time cost. Hereinafter, the time cost is simply referred to as a cost.

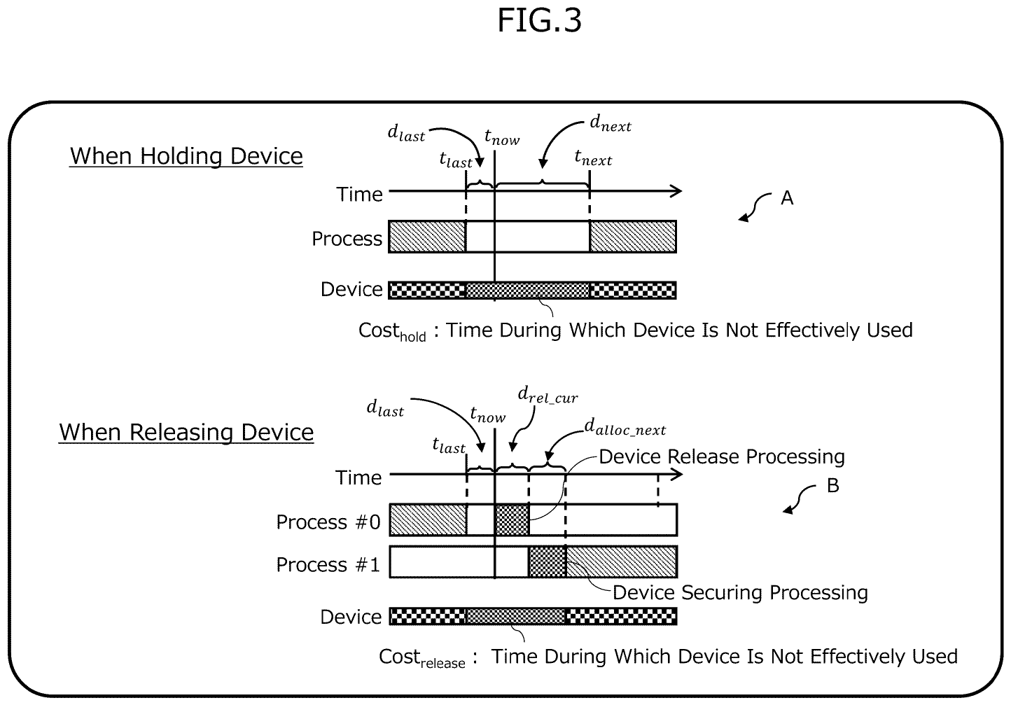

FIG. 3 is a diagram for describing a cost in the scheduling system 1 according to the embodiment. In FIG. 3, reference sign A indicates a cost in the case of holding the device, and reference sign B indicates a cost in the case of releasing the device.

Here, time t_{now} represents a current time, and tₗₐₛₜ represents an execution completion time of a process last processed by the device. In addition, tₙₑₓₜ represents a time at which the process next starts using the device. dₗₐₛₜ represents a period from time tₗₐₛₜ to time t_{now}, and dₙₑₓₜ represents a period from time t_{now} to time tₙₑₓₜ.

As indicated by reference sign A in FIG. 3, the cost Cost_{hold} (tₙₑₓₜ) in the case of holding the device can be expressed by the following equation (1).

$${Cost}_{hold} ( {t}_{next} ) = {t}_{next} - {t}_{last} = {d}_{last} + {d}_{next} \qquad ( 1 )$$

The reason why the cost is expressed as the cost Cost_{hold} (tₙₑₓₜ) at the time tₙₑₓₜ in the equation (1) is that it is unknown how long the process holds the device at the time t_{now} and the cost is determined after the time tₙₑₓₜ.

When the above equation (1) is expressed by a general formula using an arbitrary time t, the above equation (1) can be expressed as a formula of a cost function in the case of holding the device as in equation (2).

$$[ Mathematical Formula 1 ]$$

$$E ( {Cost}_{hold} ) = {Cost}_{hold} ( {t}_{now} ) + {\int }_{{t}_{now}}^{∞} {Cost}_{hold} ( t ) \frac{f ( t - {t}_{last} )}{F ( ∞ ) - F ( {t}_{now} - {t}_{last} )} dt = ( {t}_{now} - {t}_{last} ) + {\int }_{{t}_{now}}^{∞} {Cost}_{hold} ( t ) \frac{f ( t - {t}_{last} )}{1 - F ( {t}_{now} - {t}_{last} )} dt \qquad ( 3 )$$

In addition, the cost calculator 15 calculates an expected value E(Cost_{hold}) of the cost in the case of holding the device using the following equation (3). Here, since tₙₑₓₜ is unknown, the cost calculator 15 may calculate the expected value of the cost using a probability density function f(d). f(d) is a probability used d seconds after the time (tₗₐₛₜ) when the device was last used.

$${Cost}_{hold} ( t ) = t - {t}_{last} \qquad ( 2 )$$

Note that,

$$[ Mathematical Formula 2 ]$$

$$F ( x ) = {\int }_{0}^{x} f ( x ) dx$$

is given.

The expected value E(Cost_{hold}) of the cost in the case of holding the device is an example of the expected value of the second time cost in the case of continuously holding the GPU 10b (second calculation resource, device).

The expected value E(Cost_{hold}) of the cost in the case of holding the device is calculated using a probability density function representing the start time at which the GPU 10b (second calculation resource, device) is used next as a probability density with the execution completion time tₗₐₛₜ of the process last processed by the GPU 10b (second calculation resource, device) as a starting point.

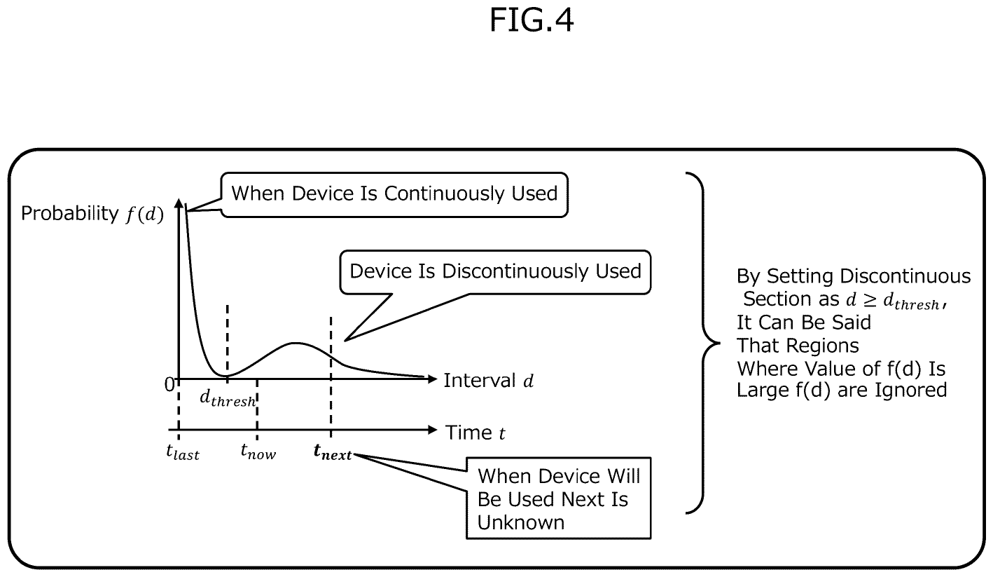

FIG. 4 is a diagram illustrating an example of a graph of a probability density function f(d).

In the graph illustrated in FIG. 4, the vertical axis represents the probability, and the horizontal axis represents the interval from the execution completion time tₗₐₛₜ of the process last processed by the device to time t. Note that d=0 represents the last time the device was used. The period before a threshold dₜₕᵣₑₛₕ represents the case where the device is used continuously, and the period after the threshold dₜₕᵣₑₛₕ represents the case where the device is used discontinuously (discontinuous section). By setting the discontinuous section as d≥dₜₕᵣₑₛₕ, it can be said that the parts where the value of f(d) is large are ignored, and this can reduce the calculation cost.

In addition, various known probability density functions may be used as the probability density function, and for example, a gamma distribution may be used.

The gamma distribution is applied to, for example, distribution of time to failure of a product. The probability density function of the gamma distribution is defined as follows.

$$[ Mathematical Formula 3 ]$$

$$f ( x ) = \frac{1}{Γ ( k ) {θ}^{k}} {x}^{k - 1} {e}^{- x / θ} for x > 0$$

θ: Average occurrence interval
k: Number of occurrences of events

In the present scheduling system 1, since it is desired to know the probability of the next occurrence, k=1. If the average occurrence interval θ is known, f(x) can be obtained.

Here, the average occurrence interval θ may be estimated based on the current user program execution position and the past discontinuous section history.

The interval until the device is used next is denoted by dₙₒᵤₛₑ. In the scheduling system 1, a weighted average according to the distance on the program is used instead of simply averaging the past dₙₒᵤₛₑ. The average occurrence interval θ can be obtained by the following equation (4).

$$[ Mathematical Formula 4 ]$$

$$θ = \frac{{\sum }_{i} {w}_{i} \times {d}_{nouse , i}}{{\sum }_{i} {w}_{i}} \qquad ( 4 )$$

In the above equation (4), wᵢ is a weight corresponding to the distance on the program.

For distance calculation, for example, a strongly connected component (SCC) may be used. The SCC is a set of nodes that can reach each other when each statement is expressed by a directed graph.

The distance between the two statements stmtᵢ and stmtⱼ can be defined as the number of SCCs traversed in the course of reaching from one statement to the other.

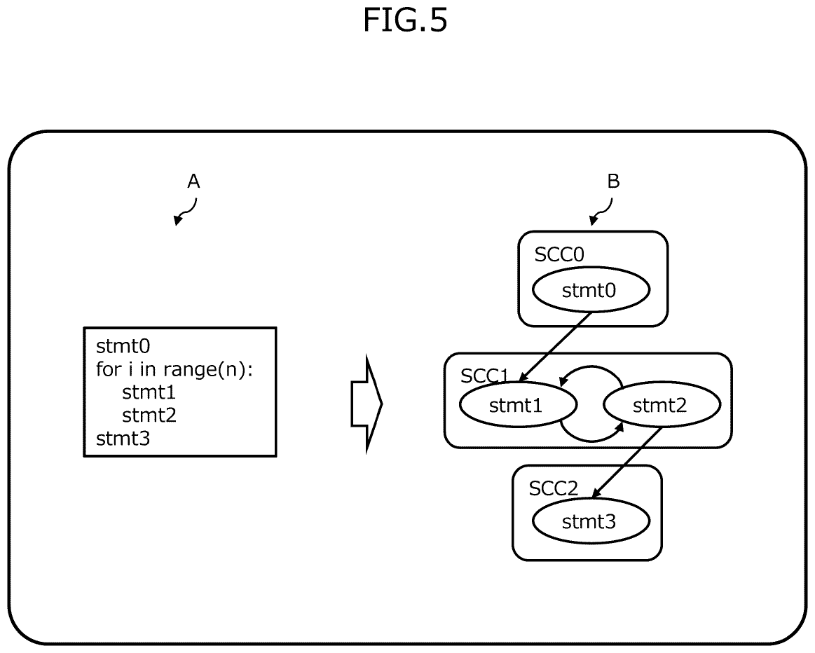

FIG. 5 is a diagram illustrating an example of program code and an SCC.

In FIG. 5, reference sign A indicates an example of program code, and reference sign B indicates an example of an SCC corresponding to the program code indicated by reference sign A.

The program code illustrated in FIG. 5 includes stmt0 to stmt3 as indicated by reference sign A. A distance between stmt1 and stmt2 is 0. In addition, a distance between stmt0 and stmt3 is 2. In such a case, for example, the weight wᵢ may be set as shown in the following equation (5).

$${w}_{i} = 1 / ( 1 + distance ( {stmt}_{cur} , {stmt}_{i} ) ) \qquad ( 5 )$$

Note that the above equation (5) is one of specific examples for determining the weight wᵢ, and is not necessarily limited to this equation (5), and can be appropriately modified and implemented.

In addition, as indicated by reference sign B in FIG. 3, the cost Costᵣₑₗₑₐₛₑ (t_{now}) in the case of releasing the device can be expressed by the following equation (6).

$${Cost}_{release} ( {t}_{now} ) = {d}_{last} + {d}_{rel \_ cur} + {d}_{alloc \_ next} \qquad ( 6 )$$

In this equation (6), d_{rel_cur} represents a period needed from the start to the completion of the device release processing, and d_{alloc_next} represents a period needed from the start to the completion of the device securing processing.

When the above equation (6) is expressed by a general formula using an arbitrary time t, the above equation (6) can be expressed as a formula of a cost function in the case of releasing the device as in equation (7).

$${Cost}_{release} ( t ) = ( t - {t}_{last} ) + {d}_{rel \_ cur} + {d}_{alloc \_ next} \qquad ( 7 )$$

d_{rel_cur} and d_{alloc_next} are obtained by the following equations (8) and (9). Note that the current number of pieces of device data is set to count_{cur}, and the next number of pieces of device data is set to countₙₑₓₜ. In addition, the current device data size is size_{cur}, and the next device data size is sizeₙₑₓₜ. In addition, the minimum latency at the time of data transfer to the device is L, and the maximum throughput is T.

$${d}_{rel \_ cur} = L \times {count}_{cur} + {size}_{cur} / T \qquad ( 8 )$$

$${d}_{alloc \_ next} = L \times {count}_{next} + {size}_{next} / T \qquad ( 9 )$$

Furthermore, the cost calculator 15 calculates an expected value E(Costᵣₑₗₑₐₛₑ) of the cost in the case of releasing the device using the following equation (10). Since it is an expected value at the time of release at the current time, the value of t=t_{now} is used.

$$E ( {Cost}_{release} ) = ( {t}_{now} - {t}_{last} ) + {d}_{rel \_ cur} + {d}_{alloc \_ next} \qquad ( 10 )$$

The expected value E(Costᵣₑₗₑₐₛₑ) of the cost in the case of releasing the device is an example of the expected value of the first time cost in the case of releasing the GPU 10b (second calculation resource, device).

The expected value E(Costᵣₑₗₑₐₛₑ) of the cost in the case of releasing the device is calculated by summing the elapsed time from the execution completion time tₗₐₛₜ of the process last processed by the GPU 10b (second calculation resource, device) to the current time t_{now}, the time d_{rel_cur} needed to release the GPU 10b (second calculation resource, device), and the time d_{alloc_next} needed to secure the GPU 10b (second calculation resource, device).

Furthermore, in a case where the user program uses the GPU 10b, in a case where the GPU 10b is not allocated to the user program, the device hooker 13 requests the device allocation server 17 to allocate the GPU 10b to the user program.

Further, the device hooker 13 may update the execution completion time tₗₐₛₜ of the process and update the device data size information 26, the discontinuous section history 23, the discontinuous section start information 24, and the device data count information 25.

A signal transmitted from the signal transmitter 11 is input to the signal processor 14, and the signal processing unit 14 initiates processing in response to the input signal.

For example, the signal processor 14 causes the cost calculator 15 to perform cost calculation each time a signal is input.

Furthermore, the signal processor 14 determines to release the GPU 10b in a case where a predetermined device release condition is satisfied. The device release condition may be, for example, that the following two release conditions are satisfied.

[Release Condition 1] The use of the GPU 10b by the process Pour is discontinuous.

[Release Condition 2] At least one of the following inequalities (a) and (b) is satisfied.

$$Inequality ( a ) : {E}_{hold} \geq {E}_{release}$$

$$Inequality ( b ) : {Cost}_{hold} ( {t}_{now} ) > {Cost}_{limit}$$

In the inequality (a), E_{hold} is an expected value of cost in the case of continuously holding the device, and Eᵣₑₗₑₐₛₑ is an expected value of cost in the case of releasing the device.

Furthermore, in the inequality (b), Cost_{hold} (t_{now}) is the current cost, and is a value obtained by applying the current time (t_{now}) to the equation of the cost function in the case of holding the device illustrated in the above equation (2). Costₗᵢₘᵢₜ is a cost limit value.

The current cost Cost_{hold} (t_{now}) is an example of a current third time cost. This current cost Cost_{hold} (t_{now}) is calculated based on the execution completion time tₗₐₛₜ of the process last processed by the GPU 10b (second calculation resource, device).

If only the determination of the expected value of the cost shown in inequality (a) is used, there may be cases where the current process continues to hold the device for a long period of time. In that case, if another process wants to use the device, it has to wait until the current process ends.

Therefore, in the scheduling system 1, the device is released even when the current cost function value exceeds the cost limit value Costₗᵢₘᵢₜ. For example, the cost limit value Costₗᵢₘᵢₜ may be determined, for example, by the cost calculator 15 inquiring of the device allocation server 17 about the device request status of other processes and determining it according to the device request status. In addition, a user or the like may set an arbitrary value as the cost limit value Costₗᵢₘᵢₜ in advance, and it may be appropriately modified and implemented.

The use of the GPU 10b by the process Pour is discontinuous as described in the release condition 1 is an example of a third condition that the use of the GPU 10b (second calculation resource, device) by the process is discontinuous.

Then, releasing the GPU 10b (second calculation resource, device) in a case where two conditions of the release condition 1 and the release condition 2 are satisfied is an example of releasing the GPU 10b (second calculation resource, device) in a case where at least one of the first condition or the second condition is satisfied in a case where the third condition that the use of the GPU 10b (second calculation resource, device) by the process is discontinuous is satisfied.

Here, in the determination of continuity of the use of the GPU 10b by the process Pour in the release condition 1, in a case where the non-use period of the GPU 10b by the process is less than the threshold dₜₕᵣₑₛₕ, it may be regarded as continuous.

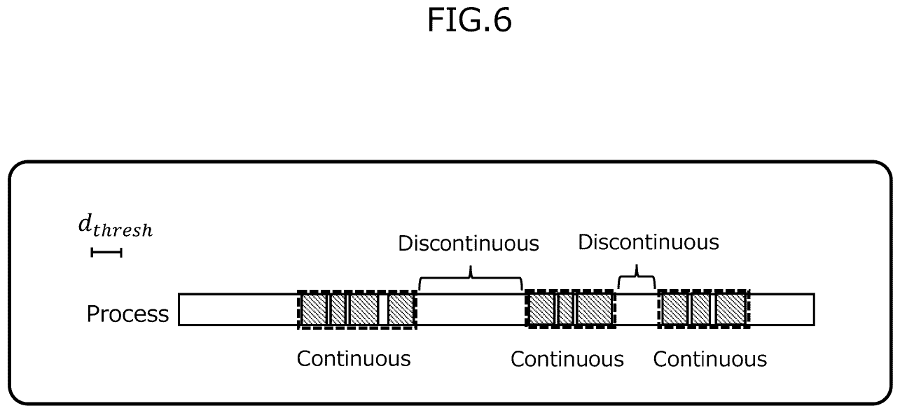

FIG. 6 is a diagram for describing a device continuity determination method in the scheduling system 1 according to an embodiment.

In FIG. 6, an example in which a process is using a device intermittently is illustrated. In the figure, a plurality of shaded rectangles each indicate a section in which the process is using the device, and an outlined portion (gap) between two adjacent shaded rectangles each indicate a section (non-use period) in which the process is not using the device.

The signal processor 14 regards a gap between two adjacent shaded rectangles, that is, a non-use period of the device by the process as continuous usage when the non-use period is less than the threshold dₜₕᵣₑₛₕ. Then, in a case where the gap between the two adjacent shaded rectangles, that is, the non-use period of the device by the process is equal to or greater than the threshold dₜₕᵣₑₛₕ, the signal processor 14 regards the non-use period of the GPU 10b by the process as discontinuous.

Furthermore, regarding the release condition 2, a probability density function f(t) of time until the GPU 10b is used next may be used for the expected value calculation. f(t) is generated based on the history of the discontinuous section in the past execution of the user program.

Furthermore, the signal processor 14 controls allocation of the GPU 10b to the user program (process). The signal processor 14 requests the device allocation server 17 to allocate or release the GPU 10b for the user program.

When the signal processor 14 determines to release the GPU 10b, it notifies the device allocation server 17 of a notification (release request) for requesting release of the GPU 10b allocated to the user program.

The device allocation server 17 allocates a device to a process (user program) in response to a device allocation request from the device hooker 13, and causes the process to perform processing. Furthermore, the device allocation server 17 may manage an allocation status of the device (GPU 10b).

Note that the function as the device allocation server 17 is known, and the description thereof will be omitted.

### (B) Operation

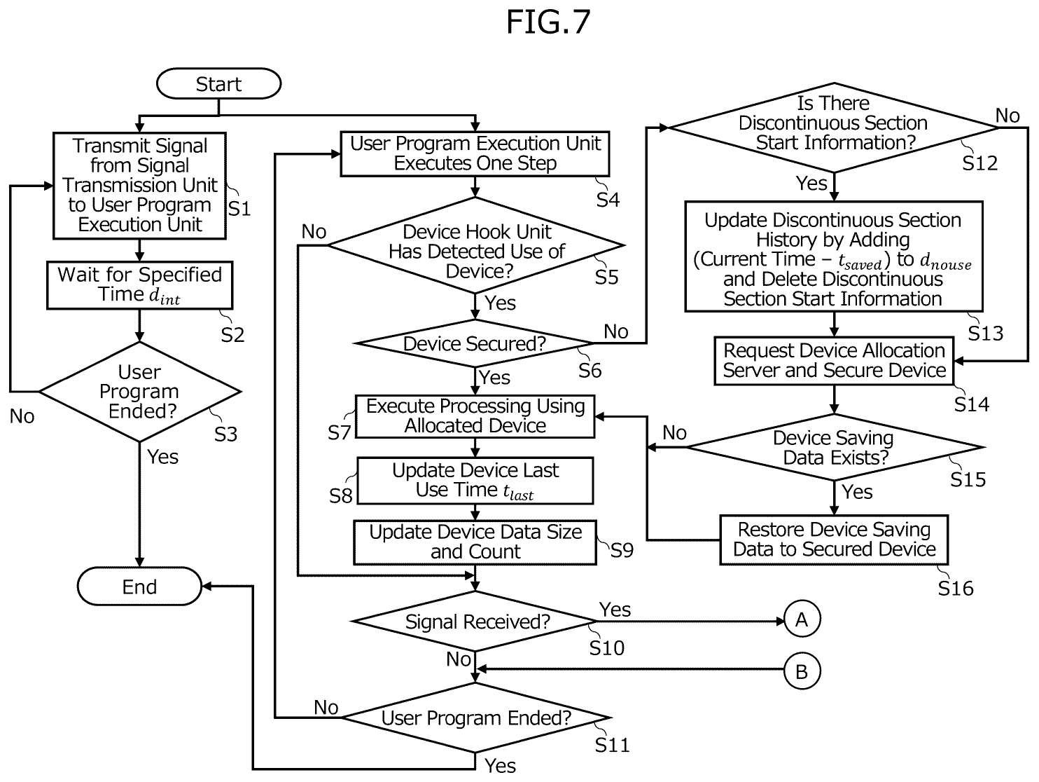

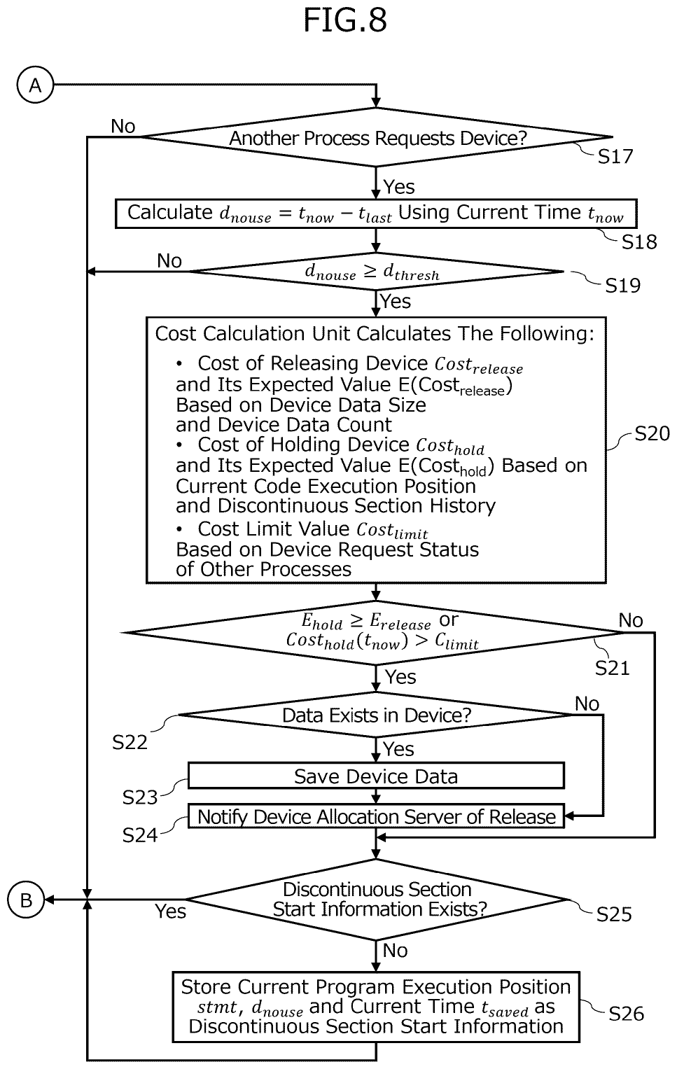

The processing in the scheduling system 1 according to the embodiment configured as described above will be described with reference to the flowcharts (steps S1 to S26) illustrated in FIGS. 7 and 8.

Note that FIG. 7 illustrates processing of steps S1 to S16, and FIG. 8 illustrates processing of steps S17 to S26.

In step S1, the signal transmitter 11 generates a signal and transmits the signal to the user program executer 12.

In step S2, the signal transmitter 11 waits for the specified time (dint), and then proceeds to step S3.

In step S3, the driver process 2 checks whether the execution of the user program by user program executer 12 has ended. If the user program has not ended (see No route in step S3), the processing returns to step S1.

When the execution of the user program by the user program executer 12 has ended (see Yes route in step S3), the processing ends.

In step S4, the user program executer 12 executes the user program by one step.

In step S5, in the management process 3, it is checked whether the device hooker 13 has detected the use of the device by the user program. In a case where the use of the device by the user program is detected (see Yes route in step S5), the device hooker 13 checks whether the device is secured in step S6. When the device is secured (see Yes route in step S6), the processing proceeds to step S7.

In step S7, the user program executer 12 executes processing (process) by the user program using the allocated device (allocated device). In step S8, the device hooker 13 updates the execution completion time tₗₐₛₜ of the process last processed by the device in the device last use time information 21 using the time at that time.

In step S9, the device hooker 13 updates the device data size information 26 and the device data count information 25.

In step S10, the user program executer 12 checks whether a signal has been received from the signal processor 14. In a case where a signal has not been received (see No route in step S10), the processing proceeds to step S11.

In addition, in step S5, in a case where the device hooker 13 does not detect the use of the device by the user program (see No route in step S5), steps S6 to S9 are skipped, and the processing proceeds to step S10.

In step S11, the user program executer 12 checks whether the user program has ended. If the user program has ended (see Yes route in step S11), the processing ends.

If the user program has not ended (see No route in step S11), the processing returns to step S4.

As a result of the check in step S6, in a case where the device is not secured (see No route in step S6), the processing proceeds to step S12.

In step S12, the device hooker 13 checks whether there is the discontinuous section start information 24 in the history information storage 16. As a result of the check, in a case where there is the discontinuous section start information 24 (see Yes route of step S12), the processing proceeds to step S13. In step S13, the device hooker 13 updates the discontinuous section history 23 by adding (current time-t_{saved}) to dₙₒᵤₛₑ included in the discontinuous section history 23. Further, the device hooker 13 deletes the discontinuous section start information 24.

In step S14, the device hooker 13 requests the device allocation server 17 to allocate a device, thereby securing a device for executing the user program.

If there is no discontinuous section start information 24 in step S12 (see No route in step S12), step S13 is skipped, and the processing proceeds to step S14.

In step S15, the device hooker 13 checks whether the device saving data 22 exists for the secured device. As a result of the check, in a case where the device saving data 22 does not exist (see No route in step S15), the processing returns to step S7.

In addition, in a case where the device saving data 22 exists (see Yes route in step S15), in step S16, the device hooker 13 reads the device saving data 22 and restores it to the secured device. Thereafter, the processing returns to step S7.

In addition, as a result of the check in step S10, in a case where a signal has been received from the signal processor 14 (see Yes route of step S10), the processing proceeds to step S17 in FIG. 8 (see reference sign (A)).

In step S17, the device hooker 13 checks whether another process is requesting the device. Here, in a case where no other process is requesting the device (see No route in step S17), the processing returns to step S11 in FIG. 7 (see reference sign (B)).

In addition, in a case where another process is requesting the device (see Yes route in step S17), the processing proceeds to step S18. In step S18, the signal processor 14 obtains dₙₒᵤₛₑ by calculating dₙₒᵤₛₑ=t_{now}−tₗₐₛₜ using the current time t_{now}.

In step S19, the signal processor 14 checks whether dₕₒᵤₛₑ is equal to or greater than dₜₕᵣₑₛₕ. In a case where dₕₒᵤₛₑ is equal to or greater than dₜₕᵣₑₛₕ (see Yes route in step S19), the processing proceeds to step S20.

In step S20, the cost calculator 15 calculates a cost Costᵣₑₗₑₐₛₑ in the case of releasing the device and an expected value E(Costᵣₑₗₑₐₛₑ) thereof using the device data size and device data count.

In addition, the cost calculator 15 calculates a cost Cost_{hold} (tₙₑₓₜ) in the case of holding the device and an expected value E(Cost_{hold}) using the current code execution position and the discontinuous section history 23.

Furthermore, the cost calculator 15 determines the cost limit value Costₗᵢₘᵢₜ according to, for example, a device request status of other processes.

In step S21, the signal processor 14 checks whether the device release condition is satisfied. That is, the signal processor 14 checks whether at least one of E_{hold}≥Eᵣₑₗₑₐₛₑ or Cost_{hold} (t_{now})>Costₗᵢₘᵢₜ is satisfied.

In a case where the device release condition is satisfied (see Yes route in step S21), next, in step S22, the signal processor 14 checks whether data (device data) exists in the device to be released. In a case where the device data exists in the device to be released (see Yes route in step S22), in step S23, the device hooker 13 saves the device data as the device saving data 22 in the history information storage 16.

In step S24, the device hooker 13 notifies the device allocation server 17 of the release of the device.

In addition, in step S22, in a case where there is no device data in the device to be released (see No route in step S22), step S23 is skipped, and the processing proceeds to step S24.

In step S25, the user program executer 12 checks whether the discontinuous section start information 24 exists in the history information storage 16. When the discontinuous section start information 24 does not exist (see No route in step S25), the processing proceeds to step S26.

In step S26, the user program executer 12 stores the current user program position stmt, dₙₒᵤₛₑ and the current time t_{saved} as the discontinuous section start information 24. Thereafter, the processing returns to step S11 in FIG. 7 (see reference sign (B)).

In addition, as a result of the check in step S19, also in a case where dₙₒᵤₛₑ is less than dₜₕᵣₑₛₕ (see No route of step S19), the processing returns to step S11 of FIG. 7 (see reference sign (B)). Furthermore, as a result of the check in step S25, also in a case where the discontinuous section start information 24 exists (see Yes route in step S25), the processing returns to step S11 in FIG. 7 (see reference sign (B)).

In addition, as a result of the check in step S21, in a case where neither E_{hold}≥Eᵣₑₗₑₐₛₑ nor Cost_{hold} (t_{now})>Costₗᵢₘᵢₜ is satisfied, that is, in a case where the device release condition is not satisfied (see No route of step S21), the processing proceeds to step S25.

### (C) Effects

As described above, in the scheduling system 1 as an example of an embodiment, a time during which a device is unavailable for effective use is treated as a cost (time cost). In addition, the cost calculator 15 calculates an expected value E(Cost_{hold}) of a cost in the case of continuously holding the device and an expected value E(Costᵣₑₗₑₐₛₑ) of a cost in the case of releasing the device.

Then, the device is released when an expected value (Costᵣₑₗₑₐₛₑ) of the cost in the case of releasing the device is lower than an expected value E(Cost_{hold}) of the cost in the case of continuously holding the device. As a result, other processes can use the device, and the utilization efficiency of the device can be improved.

In addition, the cost calculator 15 calculates the current cost (Cost_{hold} (t_{now})), and the signal processor 14 compares the calculated current cost (Cost_{hold} (t_{now})) with the cost limit value Costₗᵢₘᵢₜ. If, as a result of this comparison, the current cost (Cost_{hold} (t_{now})) exceeds the cost limit value Costₗᵢₘᵢₜ, the device is released. Accordingly, the utilization efficiency of the device can be improved.

Furthermore, in a case where the use of the GPU 10b by the process Pour is discontinuous, the signal processor 14 releases the device in a case where the expected value (Costᵣₑₗₑₐₛₑ) of the cost in the case of releasing the device is lower than the expected value E(Cost_{hold}) of the cost in the case of continuously holding the device. As a result, in the probability density function f(d) used for calculating the expected value of the cost in the case of holding the device, a region where the value of f(d) is large can be excluded, and the calculation cost can be reduced.

In addition, the cost calculator 15 performs cost calculation each time a signal is transmitted from the signal transmitter 11. As a result, it is possible to determine whether or not to release the device at a fine granularity, and it is possible to switch the device at an optimum timing.

### (D) Others

The disclosed technology is not limited to the above-described embodiments, and various modifications can be made without departing from the gist of the present embodiment.

For example, in the above-described embodiment, the distance on the program is used to calculate the weight wᵢ, but the present embodiment is not limited thereto. For example, the time t_{saved} in the history may be used, and various modifications can be made.

Furthermore, in the above-described embodiment, an example in which the device is the GPU 10b has been described, but the present embodiment is not limited thereto. The device may be a processor other than the GPU 10b. Furthermore, the device is not limited to a processor, and may be another component included in the computer 10.

In addition, some processes among the management process 3, the driver process 2, and the server process 4 may be executed by another processor instead of the CPU 10a. In addition, some (for example, the function as the device hook portion 13) of the plurality of functions included in the management process 3 may be executed by another processor.

The other processor may be, for example, any one of a micro processing unit (MPU), a digital signal processor (DSP), an application specific integrated circuit (ASIC), a programmable logic device (PLD), and a field programmable gate array (FPGA). The processor may be a combination of two or more elements among CPU, MPU, DSP, ASIC, PLD, and FPGA.

In addition to the expected value of the cost, a probability and a threshold thereof can also be used as a determination criterion in the case of releasing the device.

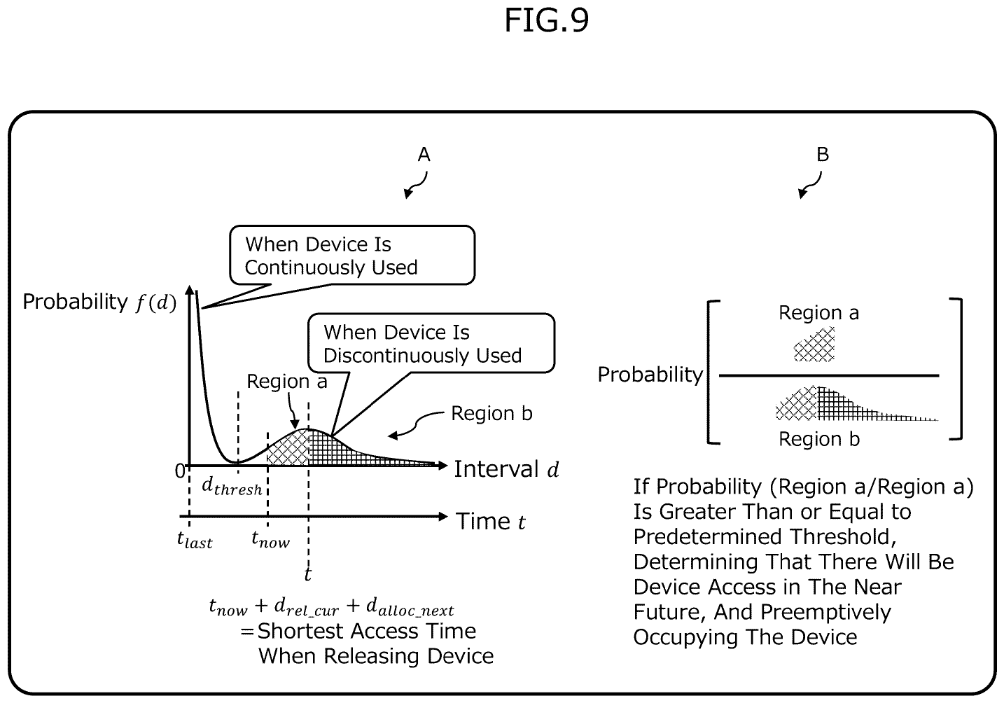

FIG. 9 is a diagram for describing a determination method based on the probability that the next access will occur in the time until the resource can be used again by the resource release.

In FIG. 9, reference sign A represents an example of a graph of a probability density function f(d), and reference sign B represents a probability that it is better to hold the device than to release the device.

In the graph of the probability density function f(d) indicated by reference sign A in FIG. 9, region b after the time t_{now} represents the total probability that an access will occur after the current time t_{now}. In addition, region a from time t_{now} to time t represents a probability that the next access will occur in the time until the resource can be used again by resource release.

When the ratio of the probability that the next access will occur in the time until the resource can be used again by the resource release to the total probability that the access will occur after the current time t_{now} is greater than or equal to a predetermined threshold, it is determined that there will be an access to the device in the near future, and preemptively occupying the device, so that the device can be used efficiently.

On the other hand, in a case where the ratio of the probability that the next access will occur in the time until the resource can be used again by the resource release to the total probability that the access will occur after the current time t_{now} is less than a predetermined threshold, it is determined that there will be no access to the device in the near future, and the device is released, so that the device can be efficiently used.

Note that t_{now}+d_{rel_cur}+d_{alloc_next} represents the shortest access time in the case of releasing the device.

Furthermore, according to the disclosure described above, the present embodiment can be carried out and manufactured by those skilled in the art.

According to an embodiment, utilization efficiency of the second calculation resource can be improved.

Throughout the descriptions, the indefinite article “a” or “an” does not exclude a plurality.

All examples and conditional language recited herein are intended for the pedagogical purposes of aiding the reader in understanding the invention and the concepts contributed by the inventor to further the art, and are not to be construed limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. A non-transitory computer-readable recording medium having stored therein an information processing program that causes a computer having a first calculation resource and a second calculation resource having higher processing performance than the first calculation resource to execute a process comprising:
during execution of a process by the second calculation resource,
calculating an expected value of a first time cost in a case of releasing the second calculation resource, an expected value of a second time cost in a case of continuously holding the second calculation resource, and a current third time cost; and
releasing the second calculation resource when at least one of a first condition that the expected value of the first time cost is less than the expected value of the second time cost or a second condition that the current third time cost exceeds a predetermined time cost limit value is satisfied.

2. The non-transitory computer-readable recording medium according to claim 1, wherein the information processing program causes the computer to execute:
releasing the second calculation resource when a third condition that the use of the second calculation resource by the process is discontinuous is satisfied and at least one of the first condition and the second condition is satisfied.

3. The non-transitory computer-readable recording medium according to claim 1, wherein
the calculating of the expected value of the first time cost includes:
calculating the expected value of the first time cost by summing an elapsed time from an execution completion time of the process last processed by the second calculation resource to a current time, a time needed to release the second calculation resource, and a time needed to secure the second calculation resource.

4. The non-transitory computer-readable recording medium according to claim 1, wherein
the calculating of the expected value of the second time cost includes:
calculating the expected value of the second time cost using a probability density function that represents an execution completion time of the process last processed by the second calculation resource as a starting point and a start time at which the second calculation resource is used next as a probability density.

5. The non-transitory computer-readable recording medium according to claim 1, wherein
the calculating of the current third time cost includes:
calculating the current third time cost based on an execution completion time of the process last processed by the second calculation resource.

6. An information processing device comprising:
a memory;
a processor connected to the memory;
a first calculation resource; and
a second calculation resource having higher processing performance than the first calculation resource, wherein
the processor executes:
during execution of a process by the second calculation resource,
calculating an expected value of a first time cost in a case of releasing the second calculation resource, an expected value of a second time cost in a case of continuously holding the second calculation resource, and a current third time cost; and
releasing the second calculation resource when at least one of a first condition that the expected value of the first time cost is less than the expected value of the second time cost or a second condition that the current third time cost exceeds a predetermined time cost limit value is satisfied.

7. The information processing device according to claim 6, wherein
the processor executes:
releasing the second calculation resource when a third condition that the use of the second calculation resource by the process is discontinuous is satisfied and at least one of the first condition and the second condition is satisfied.

8. The information processing device according to claim 6, wherein
the calculating of the expected value of the first time cost includes:
calculating the expected value of the first time cost by summing an elapsed time from an execution completion time of the process last processed by the second calculation resource to a current time, a time needed to release the second calculation resource, and a time needed to secure the second calculation resource.

9. The information processing device according to claim 6, wherein
the calculating of the expected value of the second time cost includes:
calculating the expected value of the second time cost using a probability density function that represents an execution completion time of the process last processed by the second calculation resource as a starting point and a start time at which the second calculation resource is used next as a probability density.

10. The information processing device according to claim 6, wherein
the calculating of the current third time cost includes:
calculating the current third time cost based on an execution completion time of the process last processed by the second calculation resource.

11. An information processing method for causing a computer having a first calculation resource and a second calculation resource having higher processing performance than the first calculation resource to execute:
during execution of a process by the second calculation resource,
calculating an expected value of a first time cost in a case of releasing the second calculation resource, an expected value of a second time cost in a case of continuously holding the second calculation resource, and a current third time cost; and
releasing the second calculation resource when at least one of a first condition that the expected value of the first time cost is less than the expected value of the second time cost or a second condition that the current third time cost exceeds a predetermined time cost limit value is satisfied.

12. The information processing method according to claim 11, wherein the information processing program causes the computer to execute:
releasing the second calculation resource when a third condition that the use of the second calculation resource by the process is discontinuous is satisfied and at least one of the first condition and the second condition is satisfied.

13. The information processing method according to claim 11, wherein
the calculating of the expected value of the first time cost includes:
calculating the expected value of the first time cost by summing an elapsed time from an execution completion time of the process last processed by the second calculation resource to a current time, a time needed to release the second calculation resource, and a time needed to secure the second calculation resource.

14. The information processing method according to claim 11, wherein
the calculating of the expected value of the second time cost includes:
calculating the expected value of the second time cost using a probability density function that represents an execution completion time of the process last processed by the second calculation resource as a starting point and a start time at which the second calculation resource is used next as a probability density.

15. The information processing method according to claim 11, wherein
the calculating of the current third time cost includes:
calculating the current third time cost based on an execution completion time of the process last processed by the second calculation resource.
